(19) United States
(12) Patent Application Publication
(10) Pub. No.: US 2013/0335019 A1
(43) Pub. Date: Dec. 19, 2013

(54) ELECTRONIC EQUIPMENT AND CHARGING METHOD THEREFOR

(71) Applicant: Tomoki Katsumata, Kanagawa (JP)

(72) Inventor: Tomoki Katsumata, Kanagawa (JP)

(73) Assignee: PANASONIC CORPORATION, Osaka (JP)

(21) Appl. No.: 14/001,721

(22) PCT Filed: Mar. 13, 2012
(86) PCT No.: PCT/JP2012/001738

§ 371 Date: Aug. 27, 2013

(30) Foreign Application Priority Data
Mar. 31, 2011 (JP) 2011-080291

(51) Int. Cl. H02J 7/02

(52) U.S. Cl. CPC H02J 7/025
USPC 320/108; 320/150

(57) ABSTRACT

An objective of the invention is to make it possible to switch between contact charging and contactless charging without involvement of an increase in the number of constituent components and complication of charge control. An electronic equipment has a main body block and a battery pack. The battery pack has a power receiving control block for determining whether or not to perform contactless charging of a battery cell, based on whether or not a constant voltage is applied to a thermistor terminal from a first charge control block of the main body block and a second charge control block that performs contactless charging of the battery cell with electric power transferred from a charging rack to a secondary coil on a basis of a determination result of the power receiving control block.

### TECHNICAL FIELD

The present invention relates to an electronic equipment capable of undergoing contact charging and contactless charging as well as to a charging method for the electronic equipment.

### BACKGROUND ART

By reference to FIG. 3, charge control of an existing electronic equipment 30 is described (see Patent Document 1).

When the electronic equipment 30 is put on a charging rack 50, electric power is transmitted from a primary coil 51 to a secondary coil 36. The charging rack 50 is equipped with an electric power transfer block 52 for transmitting electric power from the primary coil 51, and the electric power transfer block 52 is connected to an AC power supply 53.

When the electronic equipment 30 has received the electric power with the secondary coil 36, a power receiving control block 35 determines whether or not electric power is supplied to an external power supply connection terminal 33 from an external power supply 34.

When electric power is not supplied to the external power supply connection terminal 33 from the external power supply 34, the power receiving control block 35 supplies the thus-received electric power from the charging rack 50 to a charge control block 32. The charge control block 32 initiates contactless charging of a battery cell 41 of a battery pack 40 by way of charging terminals + and −.

During charging operation, a thermistor 43 of the battery pack 40 monitors a temperature of the battery cell 41. When the temperature of the battery cell 41 output by way of a thermistor terminal T is high, the charge control block 32 stops contactless charging. Incidentally, during contact charging operation, electric power is supplied from the external power supply 34 connected to the external power supply connection terminal 33, and the charge control block 32 initiates contact charging of the battery cell 41 of the battery pack 40 by way of the charging terminals + and −.

In the meantime, when the battery pack is equipped with the power receiving control block for performing direct contactless charging and the charge control block for charging the battery cell with received electric power, it is conceivable, as an example, to provide each of the battery pack and the electronic equipment with a terminal (an external power supply monitor terminal) by means of which the charge control block of the battery pack monitors whether or not a voltage is applied from the external power supply to the external power supply connection terminal connected to the electronic equipment.

### RELATED ART DOCUMENT

### Patent Document

Patent Document 1: JP-A-2007-336710

### SUMMARY OF THE INVENTION

### Problem that the Invention is to solve

However, when the battery pack is equipped with the power receiving control block for performing direct contactless charging and the charge control block for charging the battery cell with received electric power, a simple increase in the number of terminals leads to an increase in the number of constituent components responsible for charge control, which eventually complicates charge control.

An objective of the present invention is to provide an electronic equipment and a charging method for the electronic equipment that enable performance of switching between contact charging and contactless charging without involvement of an increase in the number of constituent components and complication of charge control.

### Means for Solving the Problem

According to one aspect of the present invention, there is provided an electronic equipment including:

a main body block including an external power supply connection terminal capable of being connected to an external power supply and a first charge control block for controlling contact charging of a battery cell from the external power supply by way of the external power supply connection terminal; and

a battery pack including
a thermistor for enabling the first charge control block to monitor a temperature of the battery cell by way of a thermistor terminal,
a power receiving control block for determining whether or not to perform contactless charging of the battery cell according to whether or not a constant voltage is applied to the thermistor terminal from the first charge control block,
a second charge control block for performing contactless charging of the battery cell with the electric power transferred to a secondary coil from a charging rack, the charging rack having a primary coil for transferring electric power to the secondary coil on a basis of a determination result rendered by the power receiving control block and a power transfer control block for controlling transfer of electric power from the primary coil, and
the battery cell.

In the above described electronic equipment, the power receiving control block may determine to perform contactless charging of the battery cell when the constant voltage is not applied from the first charge control block to the thermistor terminal; and

the second charge control block may perform contactless charging of the battery cell on a basis of a determination result of the power receiving control block by use of the electric power transferred from the primary coil to the secondary coil by the power transfer control block of the charging rack.

In the above electronic equipment, the power receiving control block may determine, during contactless charging of the battery cell, to halt contactless charging of the battery cell when the constant voltage is applied to the thermistor terminal from the first charge control block;

the second charge control block may send to the power transfer control block a notification stating that contactless charging of the battery cell is halted; and

the power transfer control block of the charging rack may halt transfer of electric power from the first coil to the second coil in response to the notification from the second charge control block.

In the above electronic equipment, the battery pack may have a charge terminal connected to the first charge control block of the main body block; and

the first charge control block may perform contact charging of the battery cell by way of the charge terminal.

According to another aspect of the present invention, there is provided a charging method for an electronic equipment including a main body block including a first charge control block for controlling contact charging of a battery cell by way of an external power supply connection terminal capable of being connected to an external power supply, and a battery pack including a thermistor for monitoring a temperature of the battery cell from the main body block and a second charge control block for performing contactless charging of the battery cell with the electric power transferred to the secondary coil from a charging rack that has a primary coil for transferring electric power to a secondary coil and a power transfer control block for controlling transfer of electric power from the primary coil, the method including:

a determination step of determining, by means of a power receiving control block of the battery pack, whether or not a constant voltage is applied from the first charge control block to a thermistor terminal connected to the thermistor of the battery pack; and

a charging step of the second charge control block of the battery pack performing contactless charging of the battery cell with electric power that is transferred from the primary coil to the secondary coil by the power transfer control block of the charging rack when the constant voltage is determined to be applied to the thermistor terminal from the first charge control block in the determination step.

### Advantage of the Invention

The electronic equipment and the charging method for the electronic equipment of the present invention enable switching between contact charging and contactless charging without involvement of an increase in the number of constituent components and complication of charge control. The electronic equipment and the charging method for the electronic equipment of the present invention enable performance of switching between contact charging and contactless charging; for instance, even when a battery voltage is low and insufficient to activate the electronic equipment, because control from the electronic equipment is unnecessary.

### BRIEF DESCRIPTION OF THE DRAWINGS

FIG. 1 is a block diagram showing a configuration of an electronic equipment 100 of an embodiment of the present invention.

FIG. 2 is a charge control flow of the electronic equipment 100 of the embodiment of the present invention.

FIG. 3 is a diagram for explaining charge control of an existing electronic equipment 30.

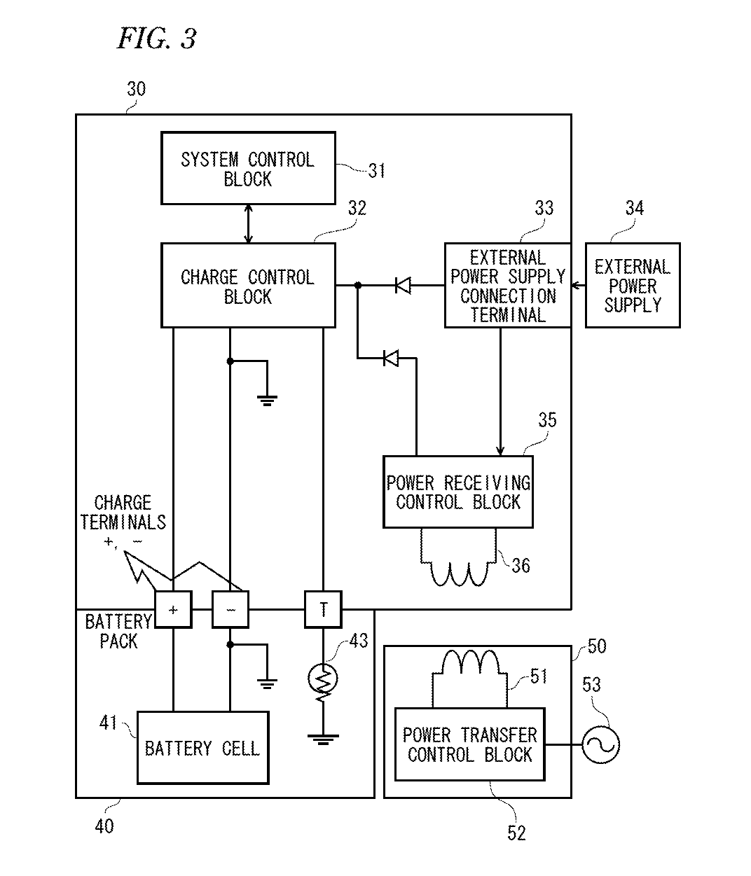

### EMBODIMENT FOR IMPLEMENTING THE INVENTION

An embodiment of the present invention is hereunder described by reference to the drawings.

In an electronic equipment 100 of the embodiment of the present invention, a constant voltage applied to a thermistor 203 of a battery pack 200 is monitored. When a constant voltage is applied, contact charging is determined to have already been initiated, and contactless charging is halted. To this end, there is utilized a specification stating that a constant voltage is applied to the thermistor 203 of the battery pack 200 only during contact charging operation.

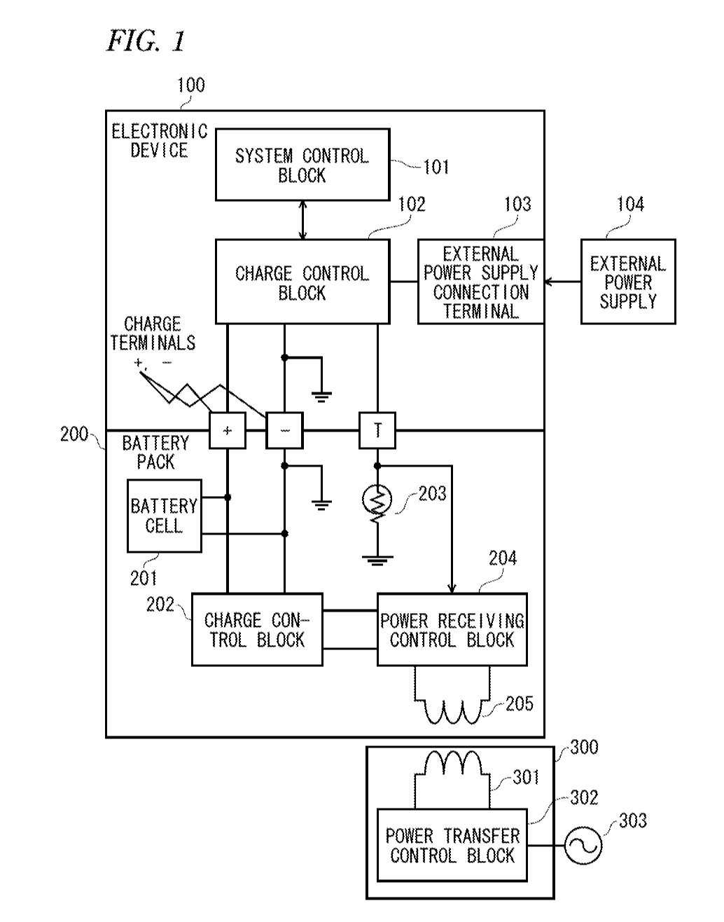

By reference to FIG. 1, a configuration of the electronic equipment 100 of the present embodiment is now described. The electronic equipment 100 shown in FIG. 1 includes a system control block 101, a charge control block 102, and an external power supply connection terminal 103 to which an external power supply 104 is connected. The electronic equipment 100 of the present embodiment is applicable to every electronic equipment complying with contactless charging and contact charging.

The system control block 101 is made up of a CPU, memory, and others, and controls the entirety of the electronic equipment 100.

The charge control block 102 controls contact charging performed by way of the external power supply connection terminal 103. The charge control block 102 is supplied with electric power from the external power supply 104 by way of the external power supply connection terminal 103, thereupon supplying the electric power to the battery cell 201. The charge control block 102 applies at this time a constant voltage to the thermistor 203.

The external power supply 104 is connected to the external power supply connection terminal 103. Electric power is supplied from the external power supply 104 to the charge control block 102 by way of the external power supply connection terminal 103.

The battery pack 200 is connected to the electronic equipment 100 by way of charging terminals + and − and a thermistor terminal T. The battery pack 200 includes the battery cell 201, a charge control block 202, the thermistor 203, and a power receiving control block 204 connected to a secondary coil 205.

The battery cell 201 supplies electric power to the electronic equipment 100. The battery cell 201 is subjected to contact charging under control of the charge control block 102 of the electronic equipment 100 and subjected to contactless charging under control of the charge control block 202 of the battery pack 200.

The thermistor 203 is an element for enabling the electronic equipment 100 to monitor a temperature of the battery cell 201 acquired during contact charging operation. A constant voltage is applied from the charge control block 102 by way of a channel passing through the thermistor terminal T only during contact charging operation. Specifically, the thermistor terminal T is a terminal for monitoring the temperature of the battery cell 201.

The charge control block 202 subjects the battery cell 201 to contactless charging on the basis of a determination rendered by the power receiving control block 204.

When the constant voltage is applied to the thermistor 203 from the charge control block 102 in the electronic equipment 100 by way of the channel passing through the thermistor terminal T, the power receiving control block 204 determines that electric power is supplied to the external power supply connection terminal 103 from the external power supply 104, therefore halting transfer of electric power from a primary coil 301 to the secondary coil 205.

When the constant voltage is not applied from the charge control block 102 in the electronic equipment 100 to the thermistor 203 by way of the channel passing through the thermistor terminal T, the power receiving control block 204 determines that the electric power is not supplied to the external power supply connection terminal 103 from the external power supply 104, therefore initiating contactless charging of the battery cell 201 by way of the charge control block 202.

When the constant voltage is supplied to the thermistor 203 from the charge control block 102 in the electronic equipment 100 by way of the channel passing through the thermistor terminal T during contactless charging of the battery cell 201, the power receiving control block 204 halts transfer of electric power from the primary coil 301 to the secondary coil 205. The charge control block 202 thereby halts charging of the battery cell 201.

The power receiving control block 204 keeps on monitoring whether or not the constant voltage is applied to the thermistor 203 from the charge control block 102 in the electronic equipment 100 by way of the channel passing through the thermistor terminal T until (1) full charge is detected during contactless charging or (2) the electronic equipment 100 is carried away from a charging rack 300 during contactless charging operation.

(1) When full charge is detected during contactless charging operation, the power receiving control block 204 halts transfer of electric power from the primary coil 301 to the secondary coil 205. The charge control block 202 thereby halts charging of the battery cell 201.

(2) When the electronic equipment 100 is carried away from the charging rack 300 during contactless charging operation, a power transfer control block 302 halts transfer of electric power from the primary coil 301 to the secondary coil 205. The charge control block 202 thereby halts charging of the battery cell 201.

As mentioned above, the power receiving control block 204 can determine whether or not the electric power is supplied from the external power supply 104 to the external power supply connection terminal 103 by way of the channel passing through the thermistor terminal T that is a terminal intended for monitoring the temperature of the battery cell 201. In addition to working as a terminal for monitoring the temperature of the battery cell 201, the thermistor terminal T doubles also as a terminal for detecting connection of an external power supply. For these reasons, the electronic equipment 100 of the present embodiment can control two charging systems without increasing the number of new terminals of the battery pack 200.

The charging rack 300 has the primary coil 301 and the power transfer control block 302 connected to an AC power supply 303. By means of the power transfer control block 302 supplied with electric power from the AC power supply 303, the primary coil 301 transfers electric power to the secondary coil 205. The primary coil 301 and the power transfer control block 302 act as an electric power transfer block.

The charging rack 300 is configured to have the electronic equipment 100 put thereon. The charging rack 300 is configured so as to be able to detect whether the electronic equipment 100 is put on or carried away, by means of a built-in sensor. In the meantime, there may also be adopted a configuration that enables detection of whether the electronic equipment 100 is put on or carried away, by means of occurrence of communication between the power receiving control block 204 and the power transfer control block 302.

When application of the constant voltage to the thermistor 203 is detected, the power transfer control block 302 halts transfer of electric power from the primary coil 301 to the secondary coil 205 in response to a notification from the power receiving control block 204.

When full charge is detected during contactless charging operation, the power transfer control block 302 halts transfer of electric power from the primary coil 301 to the secondary coil 205 in response to the notification from the power receiving control block 204.

When the electronic equipment 100 is carried away from the charging rack 300 during contactless charging operation, the power transfer control block 302 halts transfer of electric power from the primary coil 301 to the secondary coil 205 in response to the notification from the power receiving control block 204 of the battery pack 200.

### <Charge Control Flow>

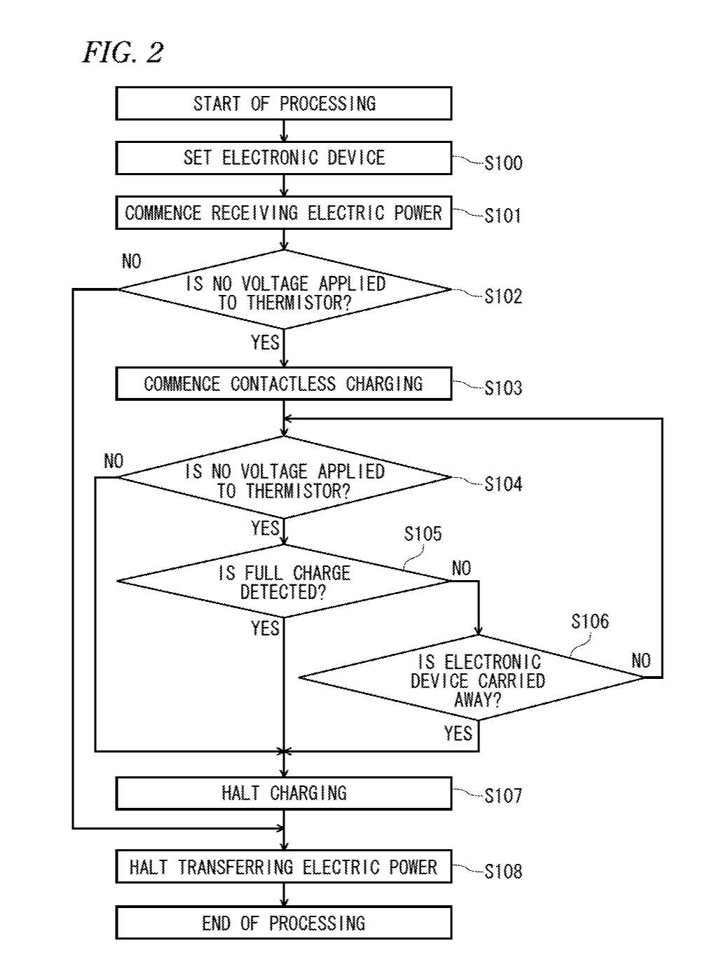

By reference to FIG. 2, a charge control flow of the electric device 100 of the present embodiment is now described. When a user puts the electronic equipment 100 on the charging rack 300 (S100), electric power is transferred from the primary coil 301 to the secondary coil 205 (initiation of power receiving operation: S101).

After the secondary coil 205 has received the electric power, the power receiving control block 204 ascertains whether or not the constant voltage is applied to the thermistor 203 from the charge control block 102 in the electronic equipment 100 (S102).

When the constant voltage is applied to the thermistor 203 from the charge control block 102 in the electronic equipment 100, the power receiving control block 204 determines that the electric power is supplied from the external power supply 104 to the external power supply connection terminal 103, thereupon halting transfer of electric power from the primary coil 301 to the secondary coil 205 (S102 and S108).

When the constant voltage is not applied from the charge control block 102 in the electronic equipment 100 to the thermistor 203, the power receiving control block 204 determines that the electric power is not supplied from the external power supply 104 to the external power supply connection terminal 103, whereupon the charge control block 202 initiates contactless charging of the battery cell 201 (S103).

When the constant voltage is applied to the thermistor 203 from the charge control block 102 in the electronic equipment 100 during contactless charging operation, the charge control block 202 halts charging of the battery cell 201, and the power receiving control block 204 halts transfer of electric power from the primary coil 301 to the secondary coil 205 (S104, S107, and S108).

The power receiving control block 204 keeps on monitoring whether or not a constant voltage is applied to the thermistor 203 from the charge control block 102 in the electronic equipment 100 until full charge is detected or the electronic equipment is carried away in the duration of contactless charging operation (S104, S105, and S106).

When full charge is detected during contactless charging operation, the charge control block 202 halts charging of the battery cell 201, and the power receiving control block 204 halts transfer of electric power from the primary coil 301 to the secondary coil 205 (S105, S107, and S108).

When the electronic equipment is carried away during contactless charging operation, the charge control block 202 halts charging of the battery cell 201, and the power transfer control block 302 halts transfer of electric power from the primary coil 301 to the secondary coil 205 (S106, 8107, and S108).

As mentioned above, in the electronic equipment 100 of the present embodiment of the present invention, the power receiving control block 204 monitors the constant voltage applied to the thermistor 203 of the battery pack 200. When the constant voltage is applied, contact charging is determined to have been initiated, and contactless charging is halted. On the contrary, when the constant voltage is not applied, contact charging is determined to have not been initiated, and contactless charging is initiated. As a consequence, the electronic equipment 100 of the present embodiment of the present invention enables performance of switching between contact charging and contactless charging without involvement of an increase in the number of constituent components and complication of charging control. Further, even when the voltage of the battery cell 201 is low and insufficient to activate the electronic equipment 100, switching between contact charging and contactless charging becomes feasible.

Although the present embodiment has provided an explanation such that the constant voltage is applied from the charge control block 102 in the electronic equipment 100 to the thermistor 203 of the battery pack 200, the present invention is not limited to the configuration. There is nothing wrong with applying a constant current to the thermistor.

While the present invention has been described in detail, or with reference to the specific embodiments, it is apparent for those skilled in the art that the invention may be modified and changed in various manners without departing from the scope and spirit of the invention.

The present application is based on Japanese Patent Application No. 2011-080291 filed on Mar. 31, 2011, the entire content of which is incorporated by reference herein.

### INDUSTRIAL APPLICABILITY

The electronic equipment and the method for charging the electronic equipment of the present invention enable switching between contact charging and contactless charging without involvement of an increase in the number of constituent components and complication of charge control operation. Further, the electronic equipment and the method yield an advantage of the ability to switch between contact charging and contactless charging even when a battery voltage is low and insufficient to activate the electronic equipment and is useful for a cellar phone, or the like.

### DESCRIPTIONS OF THE REFERENCE NUMERALS AND SYMBOLS

100 ELECTRONIC EQUIPMENT
101 SYSTEM CONTROL BLOCK
102 CHARGE CONTROL BLOCK
103 EXTERNAL POWER SUPPLY CONNECTION TERMINAL
104 EXTERNAL POWER SUPPLY
200 POWER PACK
201 BATTERY CELL
202 CHARGE CONTROL BLOCK
203 THERMISTOR
204 POWER RECEIVING CONTROL BLOCK
205 SECONDARY COIL
300 CHARGING RACK
301 PRIMARY COIL
302 POWER TRANSFER CONTROL BLOCK
303 AC POWER SUPPLY
T THERMISTOR TERMINAL

1. An electronic equipment comprising:
a main body block including an external power supply connection terminal capable of being connected to an external power supply and a first charge control block for controlling contact charging of a battery cell from the external power supply by way of the external power supply connection terminal; and
a battery pack including
a thermistor for enabling the first charge control block to monitor a temperature of the battery cell by way of a thermistor terminal,
a power receiving control block for determining whether or not to perform contactless charging of the battery cell according to whether or not a constant voltage is applied to the thermistor terminal from the first charge control block,
a second charge control block for performing contactless charging of the battery cell with the electric power transferred to a secondary coil from a charging rack, the charging rack having a primary coil for transferring electric power to the secondary coil on a basis of a determination result rendered by the power receiving control block and a power transfer control block for controlling transfer of electric power from the primary coil, and
the battery cell.

2. The electronic equipment according to claim 1, wherein the power receiving control block determines to perform contactless charging of the battery cell when the constant voltage is not applied from the first charge control block to the thermistor terminal; and
the second charge control block performs contactless charging of the battery cell on a basis of a determination result of the power receiving control block by use of the electric power transferred from the primary coil to the secondary coil by the power transfer control block of the charging rack.

3. The electronic equipment according to claim 1, wherein the power receiving control block determines, during contactless charging of the battery cell, to halt contactless charging of the battery cell when the constant voltage is applied to the thermistor terminal from the first charge control block;
wherein the second charge control block sends to the power transfer control block a notification stating that contactless charging of the battery cell is halted;
wherein the power transfer control block of the charging rack halts transfer of electric power from the first coil to the second coil in response to the notification from the second charge control block.

4. The electronic equipment according to claim 1, wherein the battery pack has a charge terminal connected to the first charge control block of the main body block; and
wherein the first charge control block performs contact charging of the battery cell by way of the charge terminal.

5. A charging method for an electronic equipment including a main body block comprising a first charge control block for controlling contact charging of a battery cell by way of an external power supply connection terminal capable of being connected to an external power supply, and a battery pack including a thermistor for monitoring a temperature of the battery cell from the main body block and a second charge control block for performing contactless charging of the battery cell with the electric power transferred to the secondary coil from a charging rack that has a primary coil for transferring electric power to a secondary coil and a power transfer control block for controlling transfer of electric power from the primary coil, the method comprising:
a determination step of determining, by means of a power receiving control block of the battery pack, whether or not a constant voltage is applied from the first charge control block to a thermistor terminal connected to the thermistor of the battery pack; and
a charging step of the second charge control block of the battery pack performing contactless charging of the battery cell with electric power that is transferred from the primary coil to the secondary coil by the power transfer control block of the charging rack when the constant voltage is determined to not be applied to the thermistor terminal from the first charge control block in the determination step.
